(19) United States
(12) Patent Application Publication
(10) Pub. No.: US 2003/0037032 A1
(43) Pub. Date: Feb. 20, 2003

(54) Systems and methods for intelligent hiring practices

(76) Inventors: Michael Neece, Hopkinton, MA (US); Christopher Faust, Lexington, MA (US); Todd Becker, Ridgefield, CT (US)

Correspondence Address: Rashida A. Karmali, Esq., 99 Wall Street, New York, NY, 10005, US

(21) Appl. No.: 09/932,004

(22) Filed: Aug. 17, 2001

(51) Int. Cl. G06F 7/00

(52) U.S. Cl. 707/1

(57) ABSTRACT

A web-based hiring application and corresponding hardware including the present invention comprises a system including, but not limited to: a) a comprehensive multi-user web-based hiring application, capable of sharing databases with other web-based companies, b) a server and hardware system set up to run the web-based application, c) a database management system, d) security for the system, e) tools for sharing and interacting with the application, via local intranets or extranets. A preferred embodiment, the IntelliHire™ provides an online system that enables customers to define candidate profiles and improves the speed of their hiring process, by improving and managing the candidate interviewing and selection process. IntelliHire™ empowers interviewers and managers to make swift, value-added decisions, and thus enables collaborative human resource decision-making.

### FIELD OF THE INVENTION

The present invention provides an online system that enables customers to define candidate profiles and improve the quality of selection, the speed of the hiring process and/or the management of the interview process. The present invention comprises a system and applications including, but not limited to: a) a web-based hiring application encompassing industry best practices, b) an interface accessible to many users at varying levels in the hiring chain, under high security, and/or c) accessibility to databases over the world wide web with partner organizations.

The present invention relates to web-based hiring practices utilizing an intranet, extranet or Internet system. The invention is capable of easing and simplifying the process of hiring personnel. The system invention has the advantages of both an internal software application and that of a web-based application. The system includes a hierarchy of users which makes the system self-contained for each group or company and also allows for cross-referencing through Internet partnerships with other organized hiring companies. The application can be upgraded regularly without interruption of regular use. Small and large businesses, as well as individual departments or business units within a corporation, can utilize the system and save both time and money, as well as hire more suitable and compatible personnel.

### BACKGROUND OF THE INVENTION

The current methods and practices of hiring are often cumbersome, costly and frustrating for hiring managers. The problem lies in the fact that hiring costs are prohibitively high, with long hiring cycles because the process is not integrated in a user-friendly manner. The increasing turnover rates of personnel make it necessary to make the hiring process as cost-effective as possible, and at the same time, to ensure that the best candidates are selected. The delays and costs that are associated with hiring practices have a negative impact on any business' profits. Current systems automate recruiting for recruiters or human resource departments, but do not facilitate interviewing and candidate selection for the hiring community, including hiring managers and interviewers within an organization.

The hiring of personnel is one of the most costly and inefficient sectors of a business. The levels of coordination that are necessary between all parties involved are high, and the people involved are often ill prepared for the task. The result is not only an inefficient hiring process, but also the hiring of poorly qualified candidates, which come at an extremely high cost to an organization.

The process of hiring involves: 1) defining job requirements, 2) finding prospective applicants, 3) sorting and interviewing applicants, and 4) making decisions on where an applicant will fit into a company. Within these broad categories there are many important decisions to be made, and up to this point the systems have been very inefficient. The job positions must be defined in terms of the needs of the company, interview teams must be coordinated, questions for each position must be standardized across the company for easier evaluation, and/or applicants must be evaluated and sorted by skills, experience, and personal profiles.

The traditional approach to hiring employees is fragmented and inefficient. The process is slow and often results in the hiring of inadequate personnel. Hiring decisions within companies are generally initiated by hiring managers who create a job profile. The job profile is then sent to another organization, such as a human resources professional or recruiter, who then finds applicants. Then a variety of individuals from multiple organizations interview the candidates, asking various questions in an uncoordinated manner, resulting in a decision based on subjective human intuition rather than objective facts gathered up through a defined and controllable business process. Each successive position starts the process over. Not surprisingly, this traditional approach has many drawbacks. Time is wasted because the interviewing and selection processes are bogged down by paper pushing and human error. There is also a lack of interviewing skills, often too many or too few interviewers spending too much or too little time interviewing. There is also the lack of implementation of a database of applicants, each time inducing a sourcing cost instead of recycling past information. There is also the lack of communication across departments and individuals, which is created when the information is not selectively available in real-time across the board. All these factors add up to lost time and money.

The recent use of the World Wide Web has sparked a new platform for employment opportunities. There are many companies having databases that store information on job applicants, and offer this information to companies who are looking to hire. This is a great asset to many people and is the start to a new form of hiring selection. Yet it is not as simple as it might seem because it takes a very savvy user to sort through the data to find usable information.

If one considers hiring as an economic decision, the employment market is comprised of supply components and demand components. “Supply” in this market is represented by sources of potential talent, such as executive search firms, job fairs, newspaper ads, and internet-based job posting services, such as Monster.com. “Demand in this market is represented by the aggregate need for talent within individual organizations across companies. The root of this demand is most often a hiring manager—a professional with a human “gap” in their organization.

With the advent of the world wide web, most new inventions utilizing Internet technology have been “supply-side” solutions, which assist human resource departments and other hiring professionals (recruiters) to access a source of potential candidates. There has been a distinct lack of solutions focused on the “demand-side” of hiring—that is, internet technology focused on assisting the hiring managers in defining their needs and making hiring decisions.

This invention focuses on meeting the needs of the “demand-side”—the hiring manager and their interview teams—by creating a system that facilitates a collaborative business process that coordinates among the various people involved in filling a need or “demand” for talent. The system provides the first comprehensive solution to “demand-side” processes of recruiting. By combining this demand-side automation with existing supply-side automation (like Monster.com), the system provides the first opportunity to integrate the demand and supply sides of the market as part of a closed loop process encompassing the hiring process. As a result, the system provides an integrated solution that encompasses the entire hiring process, from identification of an unmet “need” for talent, through the fulfillment of that need with the hiring of a qualified candidate.

There is substantial prior art on the “supply-side” of the hiring market. For example, U.S. Pat. No 5,832,497, issued to Jeffrey C. Taylor, on Nov. 3, 1988, describes an electronic automated information exchange and management system involving two databases. One system posts job applicants and the other posts employers. The system permits query of a resume base in order to identify recruitment candidates for job positions. However, the system provides no coordination in the hiring system for the employers at different levels of hiring, i.e., at selection, interviewing and/or hiring per se. It supports the human resource recruiters within a company, but not the hiring managers and interviewers.

U.S. Pat. No. 5,978,768 issued to Robert J. McGovern et al, on Nov. 2, 1999, describes a computerized job search system and method for posting and searching job openings via a computer network. This system allows a job seeker to communicate directly with a company via the Internet. Again, the system provides no guidance or coordination between the individuals at the company who are responsible for hiring.

U.S. Pat. No. 6,049,776, issued to Joseph S. Donnelly et al., on Apr. 11, 2000, describes a human resource management system for staffing projects. The system provides a common user interface for the internal and external databases in a company. Again, it provides no coordination for the hiring staff within the company to improve the hiring process.

U.S. Pat. No. 6,070,143, issued to Mathew F. Barney et al., describes a system for analyzing work requirements and linking human resource products to jobs. Again, this system provides no guidance to the hiring staff in order to improve the hiring process.

The problem with the direct link from Internet databases and companies, described in prior art above, is that there is too much information and the sorting and choosing can be as problematic as any other method. The key is to put a step in between the applicants and the companies, which can manage and sort the selection process, streamlining it for easy use. The present invention provides such a system, for example, the IntelliHire™, comprising a hiring framework that dramatically increases the speed and quality of hiring.

### SUMMARY OF THE INVENTION

The present invention comprises a system and application including, but not limited to: a) a web-based hiring application, b) a server and hardware system set up to run the web-based application, c) a database management system, d) security for the system, e) tools for sharing and interacting with the application, via local intranets or extranets.

The present invention therefore introduces the broad concept of web-based hiring which can be carried out within a company affording multiple tiers of users and an assortment of tools. This forms a standard for hiring that may be used across the board, cutting time and money spent by making information accessible in real-time and from databases of information. The application leaves room for further development and access from around the world. This invention provides an important tool to human resources departments and hiring managers to increase efficiency and worker productivity.

In one embodiment of the present invention the web-based hiring application is comprised of (1) IntelliHire administration module, (2) a Customer Administration module, (3) User modules such as (i) My Positions Module, (ii) My Candidates Module, (iii) My Interviews Module, (iv) My Evaluations Module, (v) My Report Module, and (vi) My Options Module, (4) a Search Module, (5) and a Tutorial Module. These modules are a self-contained system, able to pass on information, send reminders, and process and store data about the customer's account. Thus, the present invention simplifies and organizes the current process of hiring, while increasing productivity. In yet another embodiment of the present invention, the user module further comprises of My Questions Module, for building up the users' view and customized questions.

In one embodiment of the present invention the web-based hiring application provides a new and more efficient multi-tiered hiring system within a company, giving varying access to certain users at certain levels. Once this is accomplished there is no confusion about responsibilities. Each user can log on to an account without interfering with other users, while exchanging information in real-time, relieving the buildup of paperwork and middle men and setting up precise scheduling of important dates and meetings.

In another embodiment of the present invention the application allows for an interface and association with web-based hiring companies such as Monster.com and others, that make a pool or database by which to choose prospective applicants. Similarly, it provides an interface and association with hiring consulting firms, who offer competency-based hiring models, with databases of standard functional job descriptions, skill matrices, and interview templates to guide the hiring process. The multi-vendor integration platform that runs in this application is the Integrated Desktop Environment (IDE). It brings together job boards, agencies, search firms, college boards, consulting firms, and others. This novel approach brings together hiring businesses and service firms in a whole new way, through direct collaboration with hiring managers and interviewers. There is a positive feedback loop created where the service firms get more business by assisting the hiring businesses to better meet their needs for human talent. The vital connection between the two is the ability to manage efficiently the flow of prospective workers to the companies in need.

In one embodiment of the present invention the hiring application provides a framework that defines the companies “best practices”. This means defining position profiles and selection criteria, coordination of interviewers and focus questions, providing highly effective behavioral-event interview questions, capturing interviewer feedback and candidate evaluation, providing tools to help with decision making and support for the hiring managers, capturing and deploying a company-wide database. This “all in one” package reduces the excess time lost in decision-making and red tape. The communication between workers may occur via email through the system, further simplifying the overall process.

In another embodiment of the present invention the application is run from the Internet web server. This server is connected through an Application Server, which through a Local Area Network is connected to the Oracle Database Server. From the Oracle DB the IntelliHire Master Database is interfaced. Within this database each customer or account creates his or her own personalized database. This network of interfaces accounts for the security and rapid transmission of data from the customer to the servers and databases. These steps are necessary for a web-based application and provide access to a larger number of people than any other complimentary method. The customer needs no new hardware and the application can be leased to maximize effectiveness for the company's future investments.

In another embodiment of the present invention the use of the present invention helps train users how to become more efficient in the act of hiring. The current setup allows for managers to upgrade users from the basic level to the super level and on up the chain. The system offers adequate support and tools to help the users to learn the system allowing for more time spent using the application than in long training seminars and schooling.

In yet another embodiment of the invention, the system is used in combination with commercially available Applicant Tracking Systems software containing applicants' resumes.

IntelliHire™, a preferred embodiment, provides an online system that enables customers to define candidate profiles and improves the speed of their hiring process, by improving and managing the candidate interviewing and selection process. The application allows users to create position profiles, associate candidates with positions, schedule interviews and create evaluations. It includes a candidate profile comparison system, which facilitates interviewing, and selection of top performers that match position specific requirements. The ability to customize content, using IntelliHire™, allows different corporations to incorporate and implement hiring best practices that are specifically tailored to the corporation into the software. It thus automates the hiring process to a large extent.

IntelliHire™ brings together the tools required to hire the right people faster the first time, and delivers this functionality as an Internet based application. By bringing the process and tools to the desktops of whole departments, divisions and entire companies, and maintaining company databases with all the relevant information pertaining to the hiring process, IntelliHire™ empowers interviewers and managers to make swift, value-added decisions. By thus connecting all the fragmented pieces of the hiring process, IntelliHire™ enables collaborative human resource decision-making throughout the organization.

### BRIEF DESCRIPTION OF THE DRAWINGS

FIG. 1 shows the setup of the IntelliHire security system and network interfaces to the Internet. From their remote desktop (5), IntelliHire Users have browser-based access to the IntelliHire system through the IntelliHire Web Server (1A). Password level security is enforced by the Application Server (1B) which also provides business logic management. To determine which customer database (4) a user is authorized to access, the Application Server accesses the IntelliHire Master Database (3), which is resident on an Oracle Database Server (2). A User's password and defined privileges govern the data and features they are authorized to use within their customer database.

FIG. 2 shows the three-tiered service model of the system.

FIG. 3 shows the cascade of administrators, managers, and end users necessary to run the IntelliHire system. The cascade starts with the IntelliHire Administrator, who is responsible for creating and managing IntelliHire's customer accounts, which are separate instantiations of IntelliHire for each specific business customer. Each business customer appoints a Customer Administrator (typically from their Human Resources function) who manages the configuration and use of that business customer's IntelliHire instantiation (“customer database”). End users in each IntelliHire business customer take on numerous roles, including creating job openings (positions), defining job requirements (position profiles), assigning interview teams, selecting candidates, scheduling interviews, conducting interviews, and making hiring decisions to fulfill the job opening.

FIG. 4 shows the “summary of actors” for the IntelliHire system. Within the IntelliHire service provider, these include the system and application administrators. Within each Customer instantiation of IntelliHire, these include Customer administrators (47), super users (46) and active (normal) users (45). These Customer actors accomplish a number of individual roles, including Position Owners (42), Position Contributors (43), and Interviewers (44); each of which can be a member of interview teams (41) who evaluate Position Candidates and contact Candidate References.

FIG. 5 gives a comprehensive diagram of the various jobs associated with the IntelliHire Application Administrator. These jobs include managing business customer accounts and the individually secured customer instantiations of IntelliHire. Since IntelliHire business customers can comprise an entire corporation or individual business units/departments within a corporation, the Application Administrator also has the ability to merge customer accounts. For example, this is required when individual department-level instantiations (i.e. pilot implementations) are integrated into a corporate wide instantiation, as the business customer proceeds with a phased role-out of IntelliHire. The Application Administrator also manages IntelliHire partnership programs; such as job posting companies whose databases of candidate resumes are electronically integrated with the IntelliHire system as an optional feature for IntelliHire business customers.

FIG. 6 gives a comprehensive diagram of the various jobs associated with the Customer Administrator. In general, the Customer Administrator is responsible for maintaining the application and user level data, reports and templates within their business' instantiation of IntelliHire. In part, these jobs include: managing end-user access privileges (the authority to add new users to their IntelliHire instantiation, search and edit a user, activate or deactivate a user, grant a Basic User Super User access, etc.); creating and managing new job positions (authority to add new job openings, disable/enable the Position Sharing feature governing Contributor access to positions, etc.); defining job position profile templates (skills, qualifications, job requirements, etc.); creating report templates; and, managing other business-level data at the application and user levels.

FIG. 7 diagrams the functions of the Active User. An Active User (71) is assigned access privileges by the Customer Administrator or through self-registration. The Customer Administrator can promote an Active User to Super User, but an Active User cannot change his or her own access privileges. An Active User can set-up or modify his or her own administrative options (72), run user reports (73), create new job positions, and request to be on an Interview Team (74). An Active User can be a Position Owner, Position Contributor, and/or an Interviewer. An Active User has the ability to search all positions in the system and see the position profile, Owner and position status. An Active User can create position data, but is not able to edit/delete any positions that are owned by other Users. If an Active User is linked to a position as a Contributor or Interviewer, the Active User has certain access privileges (modify and view) as the Position Owner. However, Active Users who are not Position Owners are not able to see certain information, such as Salary and Bonus for positions, including all position related information.

FIG. 8 diagrams four ways to create a new Position Profile from the New Position screen. Users can create a new Position Profile using the Position Wizard, pre-defined Position Templates, by copying an existing Position. A Super User has a “See All” privilege for all public and private Position Profile, and from “scratch” using a Blank Position Form. Selecting Position Wizard brings the user to the first page of the Position Wizard, which then takes the user through the various steps involved in defining a new Position Profile. By selecting Templates, the user is brought to the Template Search page to find a suitable Position Template. By selecting Copy Existing Position, the user is brought to the Search All Positions page to find a similar existing position, which is then copied, modified and saved as a new Position Profile. By selecting Blank Form, the user is brought to a Blank Profile form, which the user can directly fill out. From the New Position Page, users can also access “My Positions” page, “My Candidates” page, “My Interviews” page, and “My Reports” page from the heading navigation bar.

FIG. 9 is a flow chart describing the process of creating a New Position using the Position Wizard. The Wizard guides an Active User through the various steps involved in creating a New Position: define New Position details, such as title, salary, bonus, manager, etc; describe “required” and “preferred” Experiences; select from a list of pre-defined Behaviors, which the user then rates by Importance; select from a list of pre-defined Professional Skills which the user then rates by Importance; define Organizational Fit within three categories, including Work Environment, Corporate Culture, and Other; and, enter position responsibilities.

FIG. 10 diagrams the method of creating a New Position by using a blank form. Within the form, the User must define the following characteristics of the New Position: title & reference number; public or private (viewable by all users or only by Position Owner, Position Contributor, and Interviewers); Approval Date; Location; Department; Hiring Manager; Number of Openings (if more than one, the system prompts the user to enter unique reference numbers for each position); Salary and Bonus; Education, Degree and Major; Years of Work Experience; a list of Experiences, rated as required or preferred; a list of Behaviors, numerically ranked and rated as required or preferred; a list of Professional Skills, numerically ranked and rated as required or preferred; a list of statements regarding Organizational Fit, numerically ranked and rated as required or preferred; and a list of Responsibilities further describing the Job Description. Once completed, the User can proceed to the Profile Interview Question module, in which the user can associate interview questions with the various characteristics of the New Position.

FIG. 11 defines the Position Profile and the associated fields. These fields include: title & reference number; public or private (viewable by all users or only by Position Owner, Position Contributor, and Interviewers); Approval Date; Location; Department; Hiring Manager; Position Owner; Number of Openings (if more than one, the system prompts the user to enter unique reference numbers for each position); Salary and Bonus; Education, Degree and Major; and, Years of Work Experience. As a separate set of affiliated tables, each Position Profile must define related Competencies: a list of Experiences, rated as required or preferred; a list of Behaviors, numerically ranked and rated as required or preferred; a list of Professional Skills, numerically ranked and rated as required or preferred; a list of statements regarding Organizational Fit, numerically ranked and rated as required or preferred; and a list of Responsibilities further describing the Job Description. Each Position Profile is also associated with Interview Questions associated with the various characteristics of the New Position.

FIG. 12 details the various data tables associated with Position Profiles. It shows the relationships between a Position Profile and the Active User Roles (Current and Future Position Owner, Position Contributor, and Interviewer). The Position Profile is also related to the Candidate data, describing personal information for each Candidate of a new Position, the relationship to and contact information of each Candidate's References, as well as the Position Candidate data describing the Candidate's status in the process of interviewing for the new Position. The Position Profile is also related to Interview information, including Interview Scheduling, Interviewer Notification, and Interviewer Competency Assignments, which define the specific Competency areas on which each Interview Team Member will focus when evaluating candidates (e.g. one interviewer may focus on Professional Skills, while another will delve into a candidate's Organizational Fit).

FIG. 13 is a flow chart showing how the Interview process is organized, managed, and coordinated through the application.

FIG. 14 diagrams how the candidate is evaluated and how references are checked. This separates yet coordinates the responsibilities the application offers and manages.

FIG. 15 describes the fields that must be filled out once the evaluation is complete.

FIG. 16 diagrams the fields that the user must fill out for a Custom Report after the interview session.

FIG. 17 describes how position profiles can be created (see FIG. 8) and managed.

FIG. 18 shows the various steps involved in the interview preparation stage which includes building an Interview team and coordinating the team.

FIG. 19 gives an example of how the IntelliHire system's users can submit/view the evaluations of candidates, and also check the candidate's references.

FIGS. 20 and 21 show the different levels/roles of the users of IntelliHire (FIG. 20) and how the different users interact with each other (FIG. 21).

FIG. 22 describes computer screens which indicate that IntelliHire enables a user to manage all of the positions from one location.

FIG. 23 describes computer screens which indicate that IntelliHire helps a user to coordinate interviewing teams and focus interviewer questioning to avoid redundancy.

FIG. 24 describes computer screens which indicate that IntelliHire includes an extensive database of behavioral event interview questions that are specific to each position.

FIG. 25 describes computer screens indicating that IntelliHire provides support to easily manage all of the candidates and evaluate them.

FIG. 26 describes computer screens indicating that IntelliHire organizes for the user all candidate evaluations in empirical form.

A number of abbreviations as used herein in the specification, include: Admin (administrator), Cat (category), Col (column), Cust (customer), Def (default), Desc (description), Edu (education), Eval (evaluation), Exp (experience), (Gen) (general), HM (hiringmanager), Info (information), Int (interview), Max (maximum), Num (number), Org (organization), Prof (professional), Que (question), Ref (reference), Rpt (report), Syn (synonym).

### DETAILED DESCRIPTION

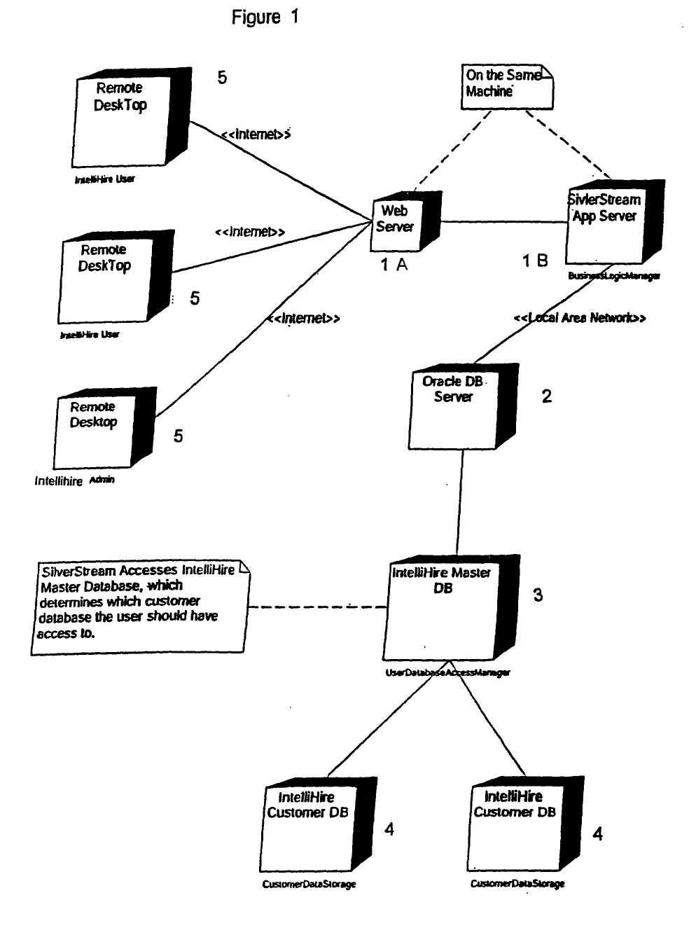

Referring initially to FIG. 1, illustrated is an embodiment of the System Data Security using multiple databases. The World Wide Web 1 being the starting platform for the system, then branches out into secondary servers such as Silverstream and Oracle 2. These servers are interfaced with the System Master Databases 3 that in turn harbors individual accounts for customers, each with individual databases 4 within the master database system. The entire system can be accessed through remote desktop computers 5 being part of either an intranet or extranet or as an individual.

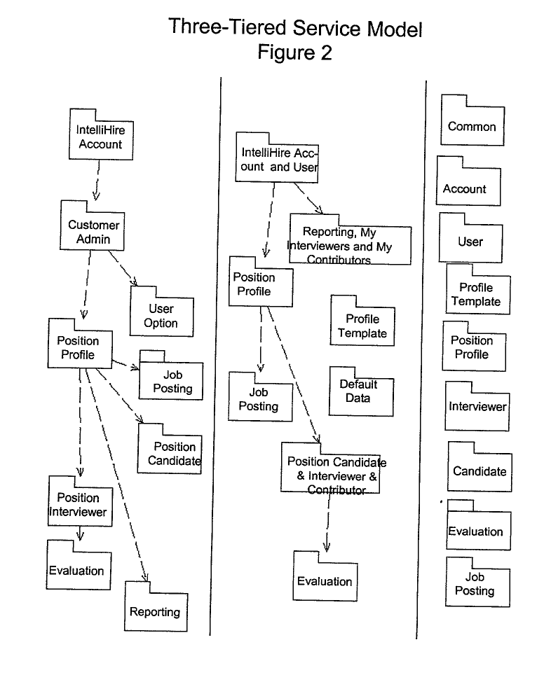

FIG. 2 showing the Three Tiered Service Model defines “user access” levels (or services) as Security Access Levels or Multi User Access Levels. The purpose is to show which users have access to which data, and more specifically to which UI areas.

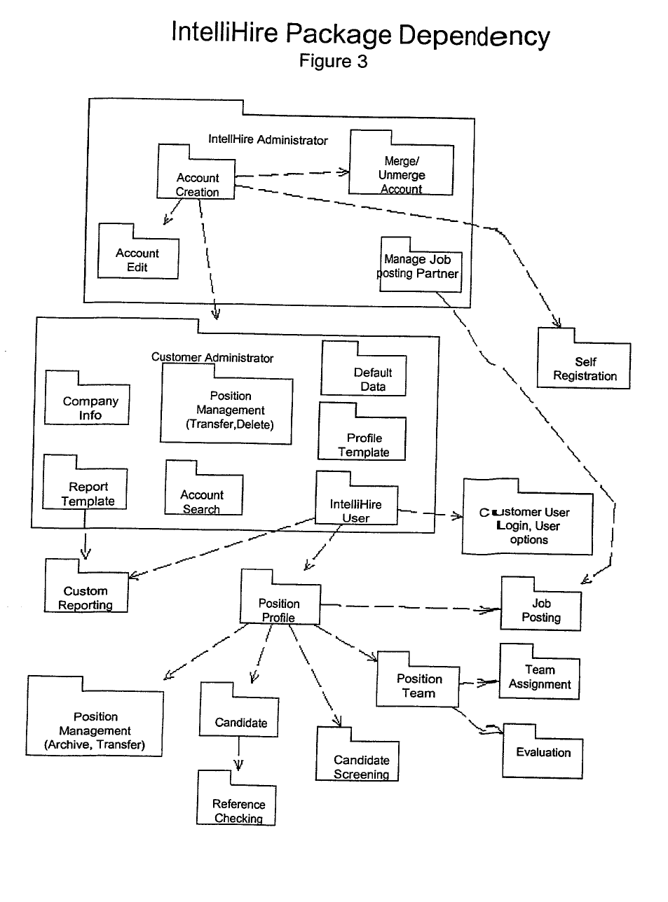

The diagram in FIG. 3 shows the hierarchy and Package Dependency of the System. The first level involves the IntelliHire Administrators who will deal with customer accounts and Manage Job Posting Partners. Managing accounts could include creating new accounts, editing accounts and merging accounts. The Second tier is the Customer Administrator who will be part of the company using the application. He is responsible for entering default data, setting up the account users, inputting company information as well as others. From there the program breaks down the responsibilities into bite size portions for all the individuals necessary in the hiring process. Teams can be created to increase efficiency.

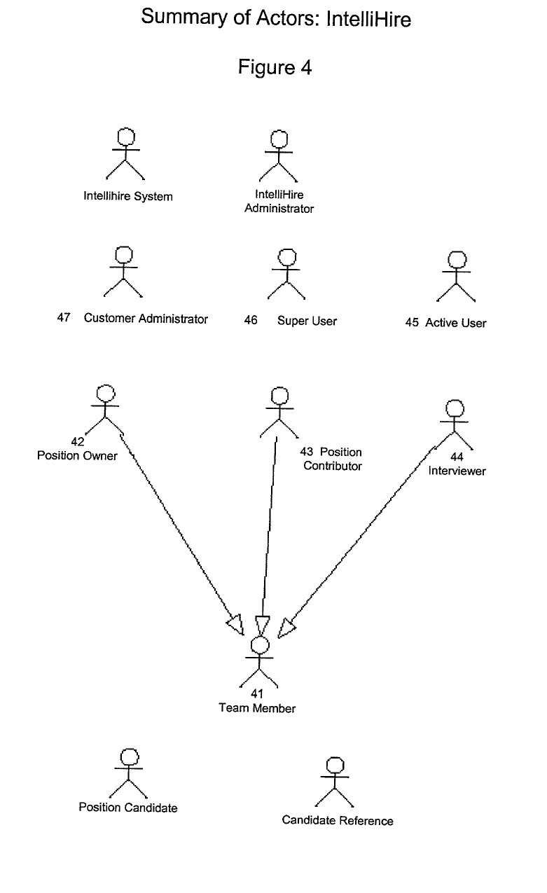

The diagram in FIG. 4 shows the “Summary of Actors” necessary for the hiring application to run smoothly. The important fact to be drawn from this is that the team member 41 can be any of the following: position owner 42, position contributor 43 or the interviewer 44. They are the “nuts and bolts” of the operation and along with the Users 45 and Super Users 46 make up the staff to be managed by the Customer Administrator 47.

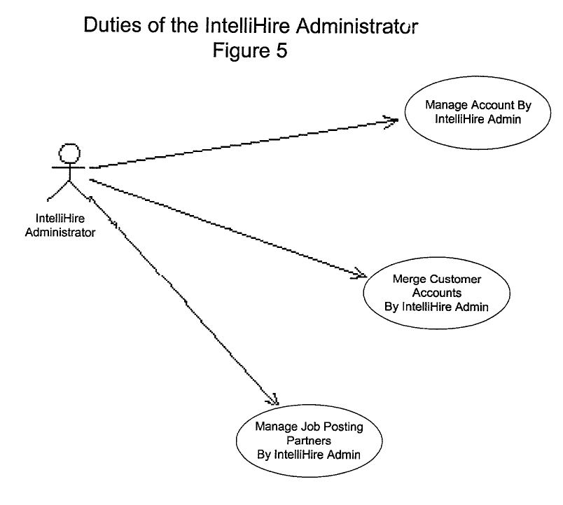

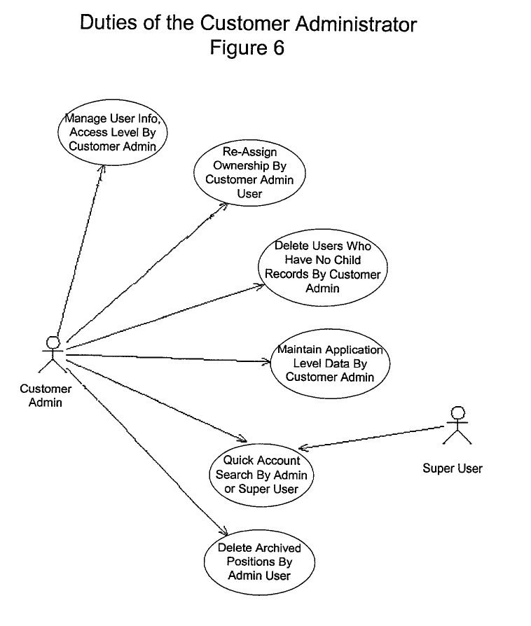

FIG. 5 and 6 further clarify and enumerate the duties of the IntelliHire and Customer Administrator from FIG. 3.

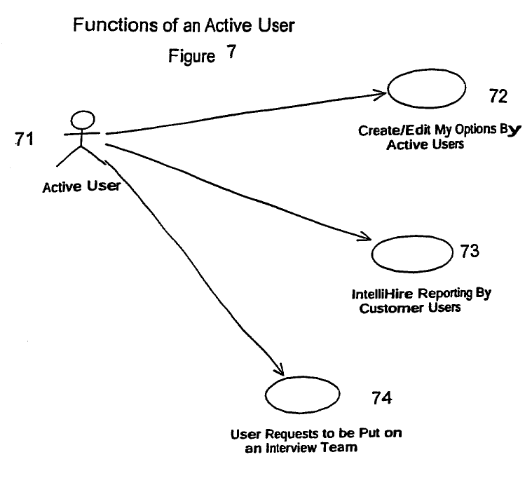

FIG. 7 details the responsibilities of the Active User 71 Administrational, Reporting and Request duties. These are mainly to access the application for use in creating and editing My Options by Active users 72, handle reporting by Customer Users 73, and handling User requests to be put on interview teams 74.

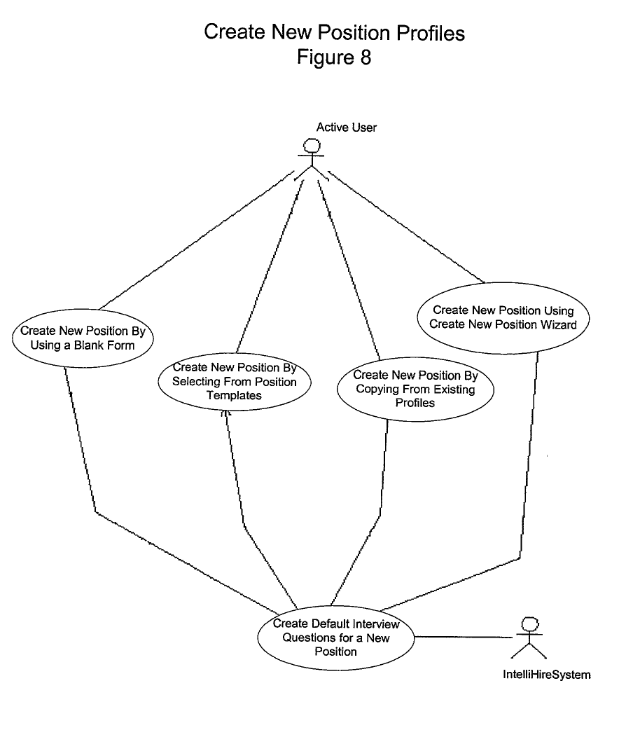

FIG. 8 details the application prompts for an Active User who wants to Create a New Position Profile. The application allows the user to create a new position by using a blank form, by selecting from various positions, by copying from an existing position, and by using the Position Wizard. The application allows for customizing of all profiles as well as editing of current files. Once the position profile is filled then the system will set up a myriad of default interview questions by new position.

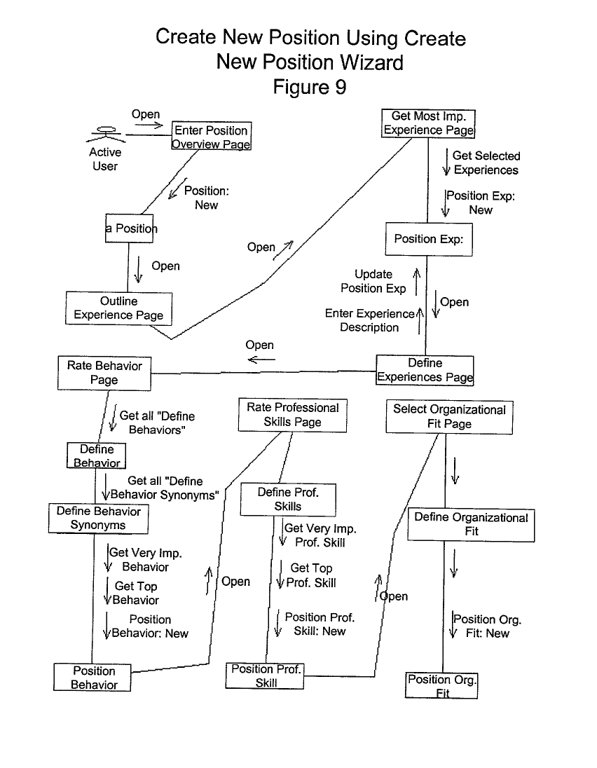

FIG. 9 diagrams the option of using the Position Wizard. The flow chart lets the user define the values of the new position while also defining the importance of certain skills and behaviors specific to the job. This platform will help the user in the examination phase to get the position filled by the best-fit potential candidate.

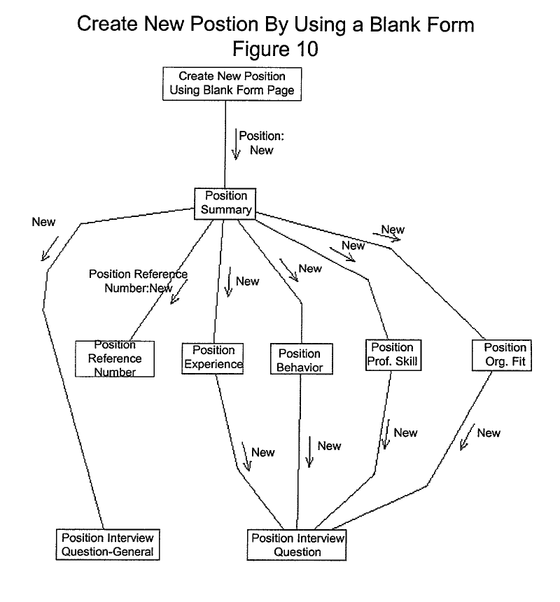

FIG. 10 diagrams the option of Creating a New Position from a Blank Form. The position needed might be defined outside the confines of the Position Wizard and therefore need to be customized. The Blank Form leaves the user room to give a position summary, a reference number and criteria for the position experience, behavior, professional skills and organizational fit.

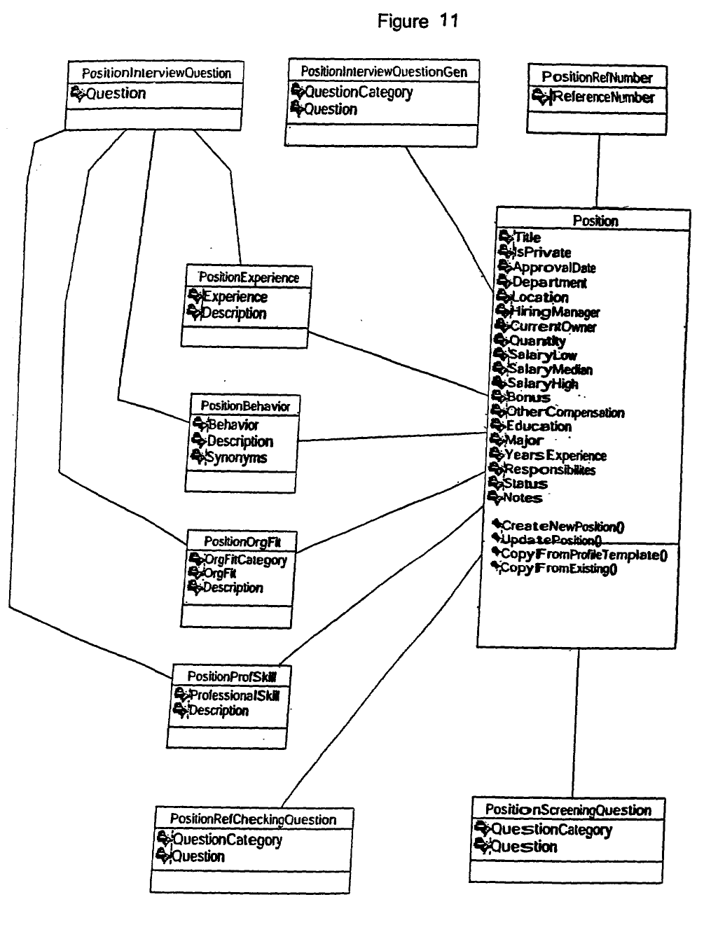

FIG. 11 enumerates the fields, which are to be filled out when creating a position profile. These include title, department, salary, education, status, etc. The user then fills out the fields on the perspective interview questions. The application uses four distinct criteria for the questions, position experience, position behavior, organizational fit, professional skills, and reference checking.

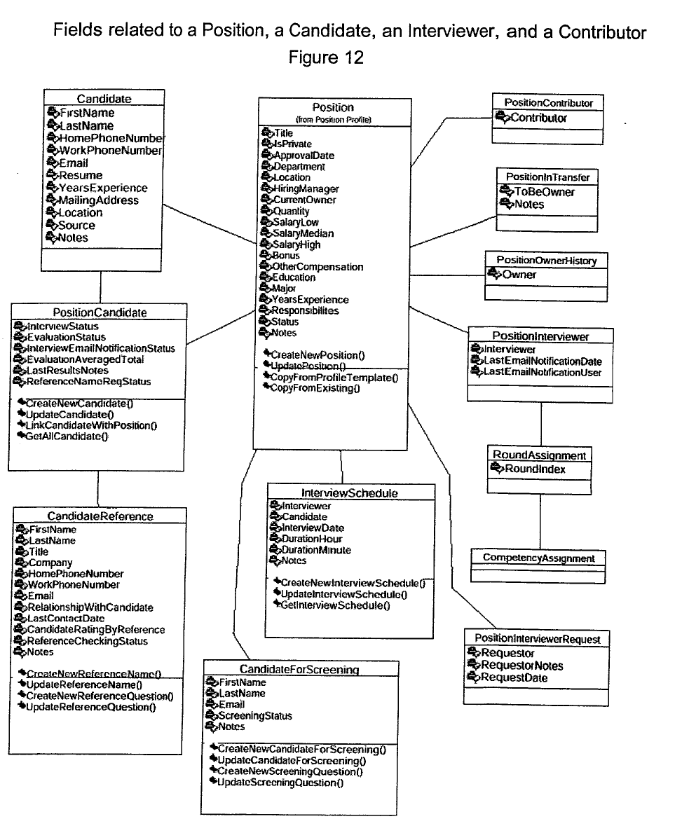

FIG. 12 combines the flow charts and fields necessary for the Position Candidates, Interviewer and Contributors. The user follows the application to get the interview schedule and to have the proper information on the contributors, and the candidate, including references. All interview questions and information is ready for the user at the touch of a button.

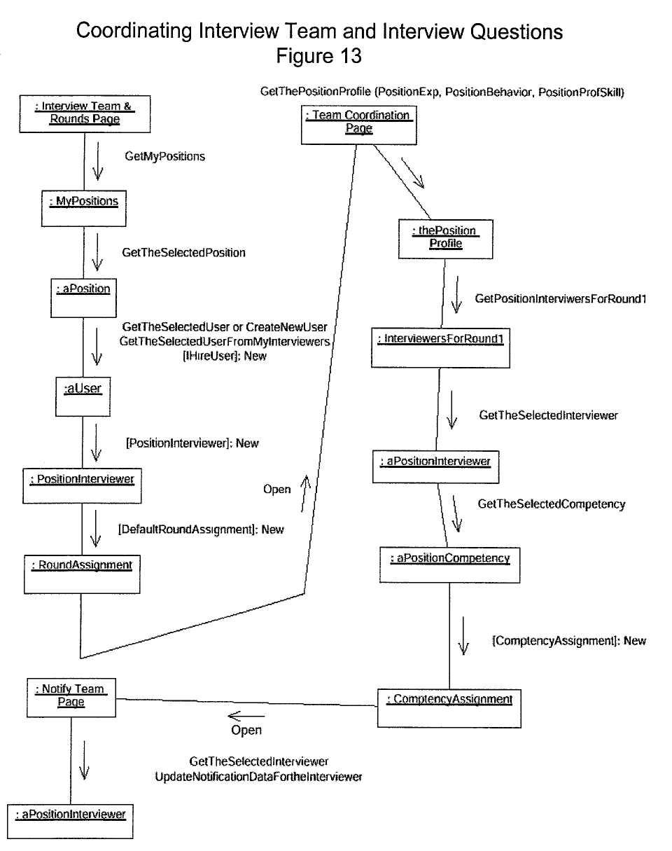

FIG. 13 shows the process of putting together an interview team, coordinating questions and notifying each team member of their responsibilities. The system allows for a team coordination page. Each member is assigned a task and when each task is done and reported, the system notifies each team member. The team members are responsible to verify scheduling of interviews, editing questions and printing interview packages. The data entered is processes by the specifications entered for the importance of each category. Notification will come through reminders after log in and via email.

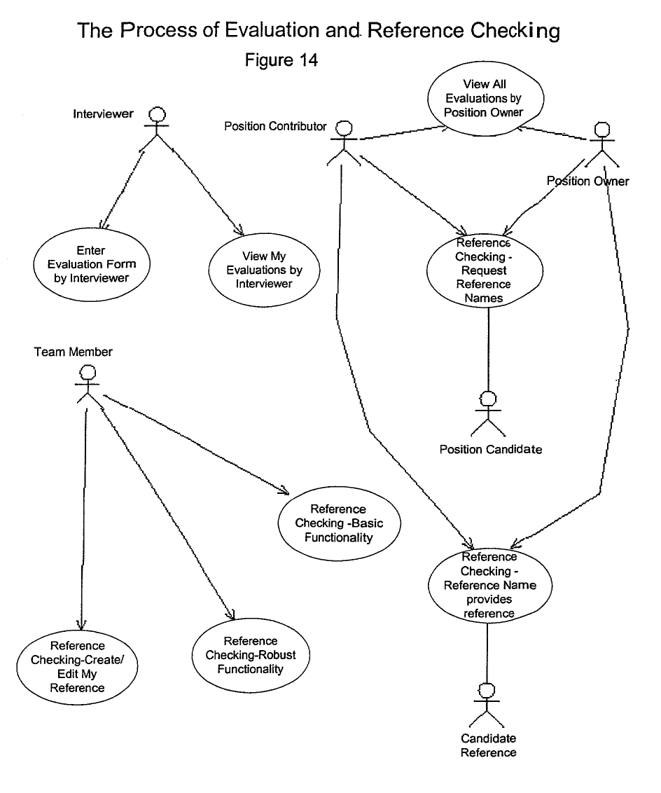

FIG. 14 diagrams a flow chart of the process for evaluation and reference checking. All evaluation forms are entered by the interviewers in the My Evaluations portion of the application. All evaluations are electronically sent and viewed by both the position contributors and position owners after the interview. References are to be checked through team members in both basic and robust functionality.

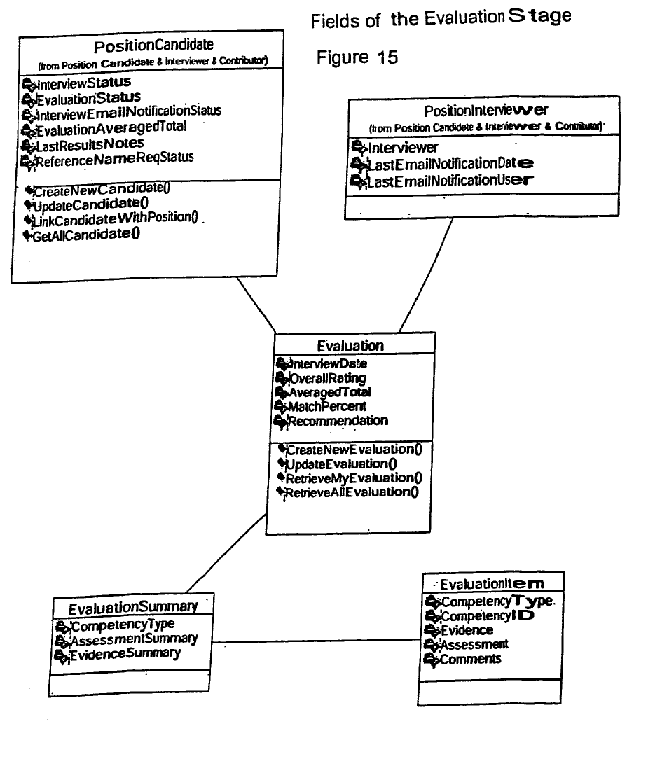

FIG. 15 shows the field that the user must fill out after the interview stage. This evaluation stage lets the user organize all of the data pertaining to the job position and all the candidates. The system will process the data at the user's discretion and then email out notifications to all the candidates on their status for the position. The processing of the data puts together interviewers overall rating, average total, match percentage, and recommendation. This process results in a summary which is then distributed throughout the team for analysis.

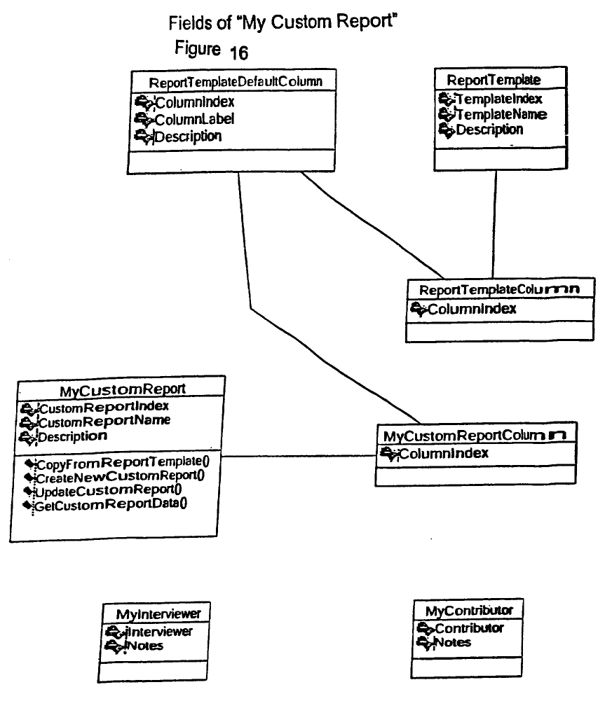

FIG. 16 shows the contributors to the final report and how My Custom Report is put together. The Template for the report is used to standardize the process and make for easier decision making.

Users can access the IntelliHire™ application from a standard web browser. Hiring managers and Interviewers are the primary users of IntelliHire™. Once logged in, users can manage and share position profiles, candidates, resumes, interview questions, and candidate evaluation. The main steps involved in the hiring process are: 1) Defining the Positions, 2) Coordinating the Interview Teams, 3) Organizing the Interview Questions, 4) Evaluating Candidates and 5) Reviewing the Candidate Evaluations.

The process flow involves four main modules within the IntelliHire system: 1) Positions module, 2) Candidates module, 3) Interviews module, and 4) Reports module.

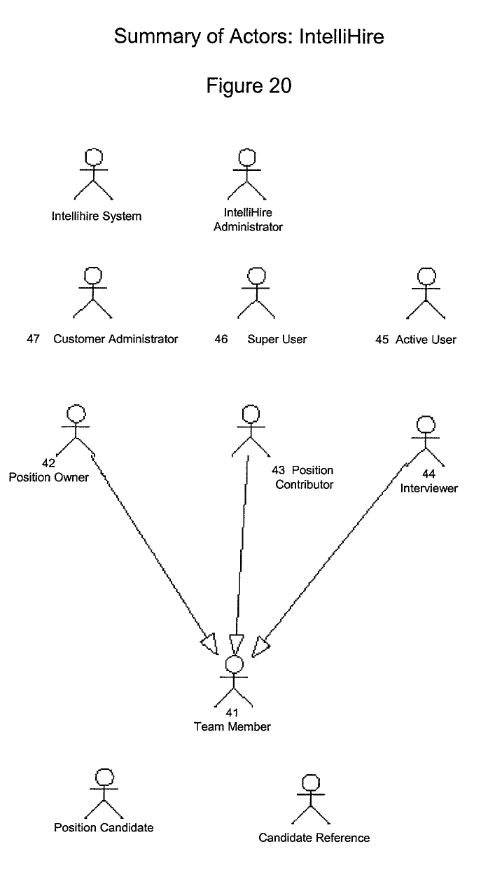

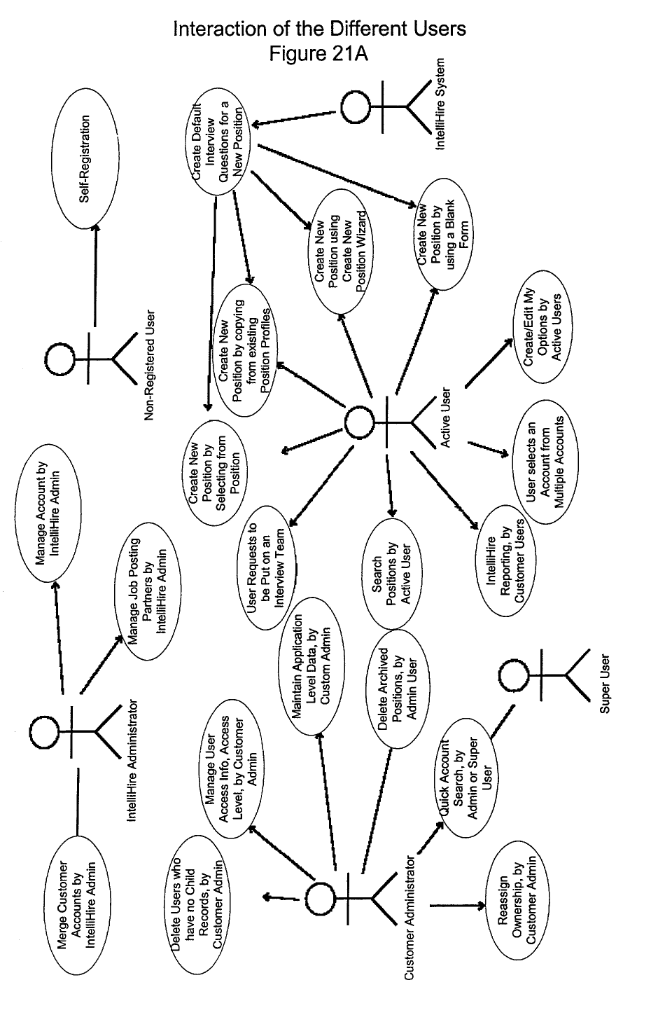

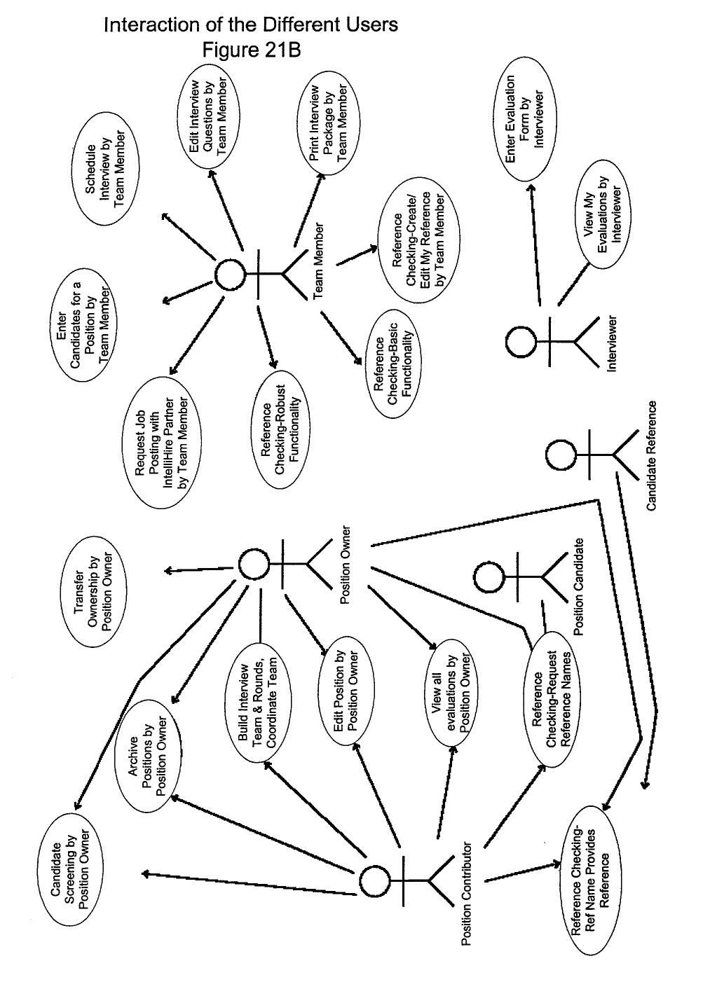

The IntelliHire system incorporates the above-mentioned steps to attain an improved candidate interviewing and selection process. FIGS. 20 and 21 show the different levels/roles of the users of IntelliHire (FIG. 20) and how the different users interact with each other (FIG. 21). Through this process of interaction, the different users implement the above-mentioned steps to bring about the goal of reducing hiring costs.

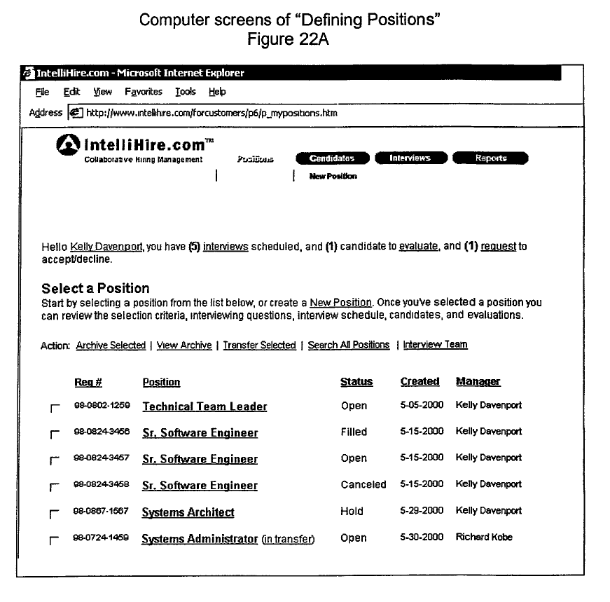

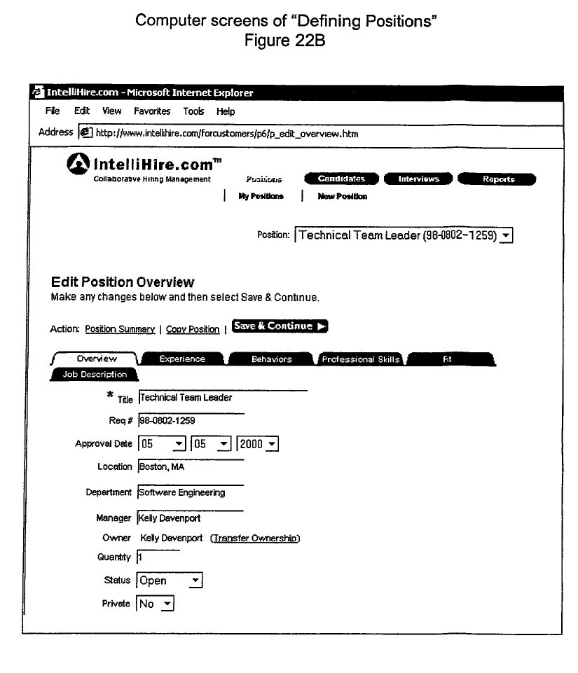

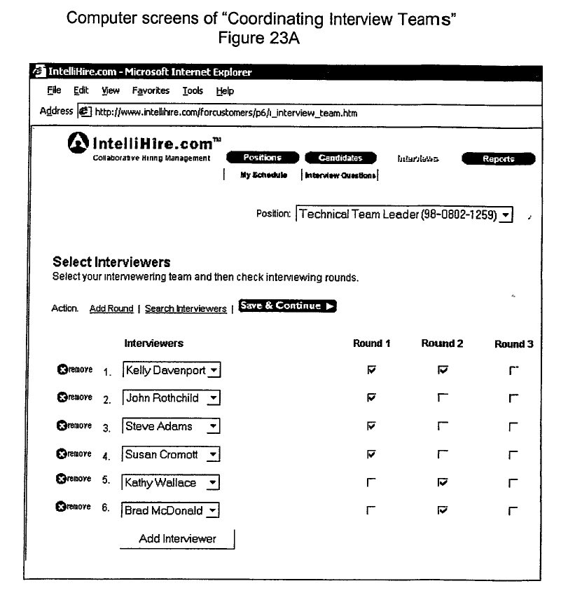

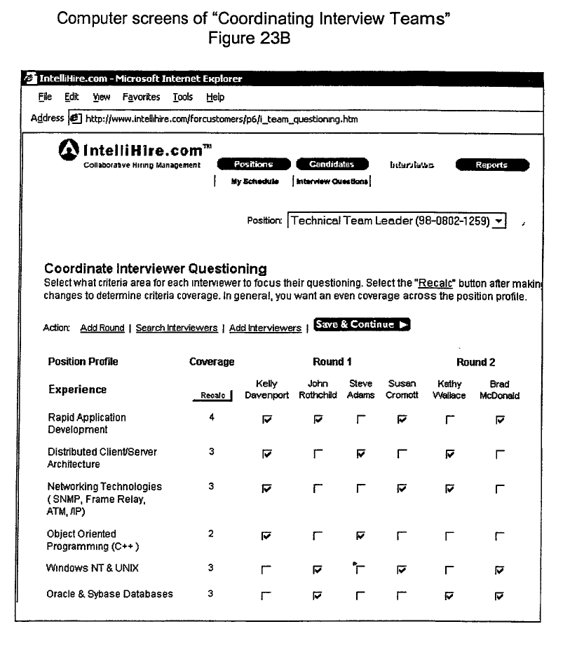

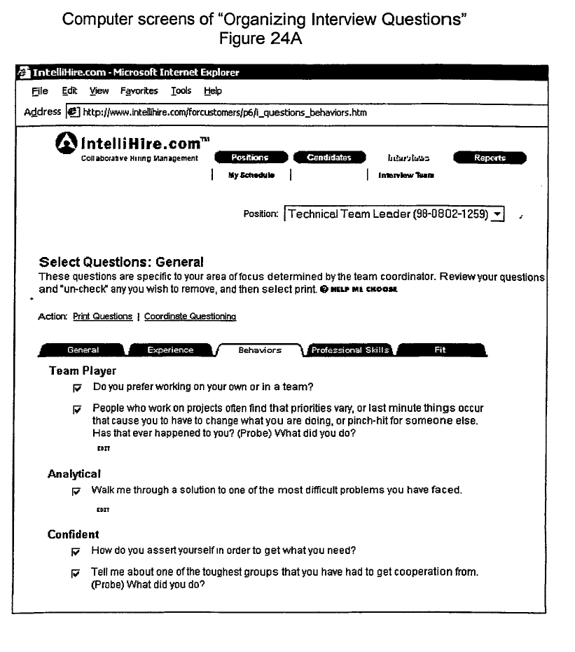

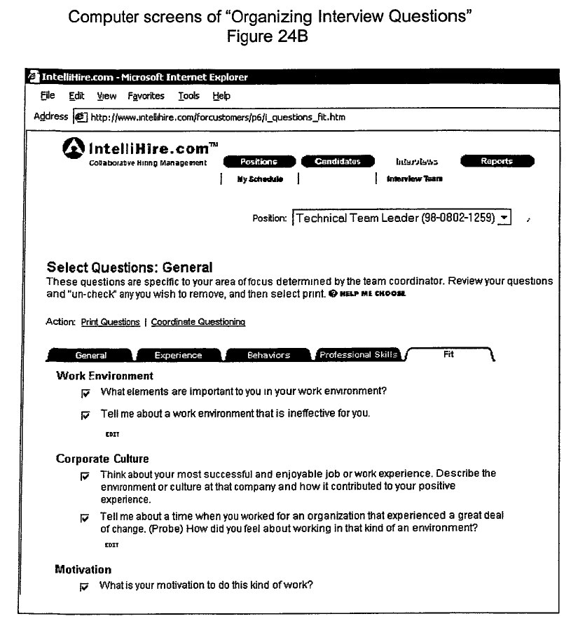

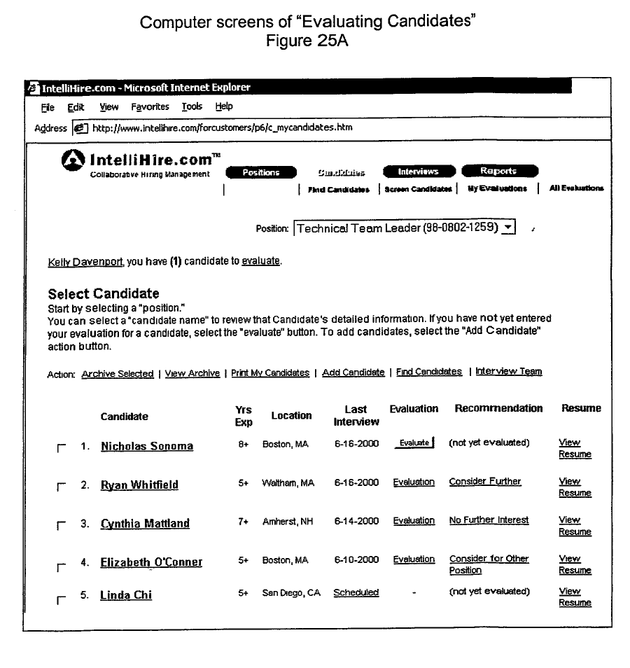

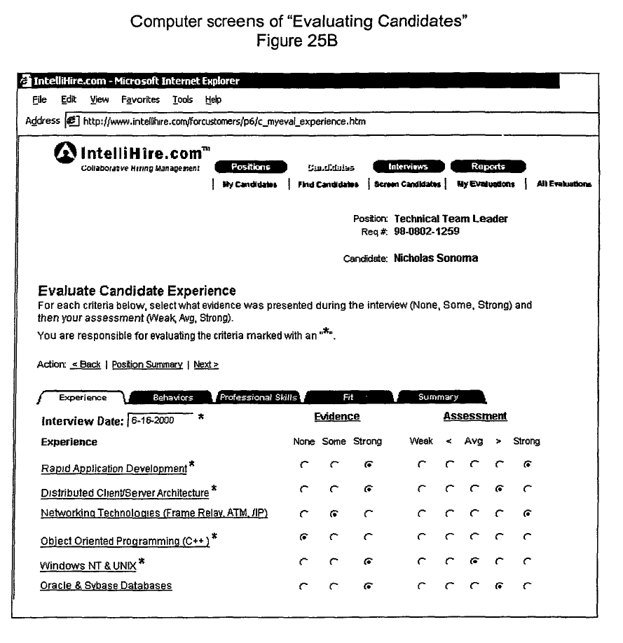

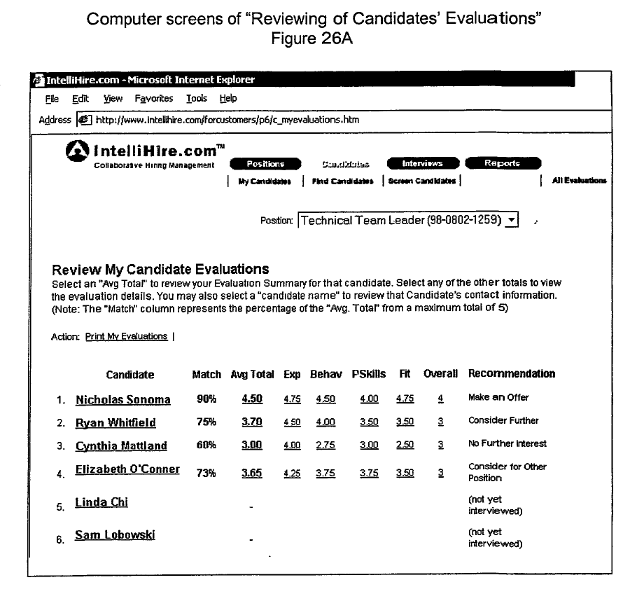

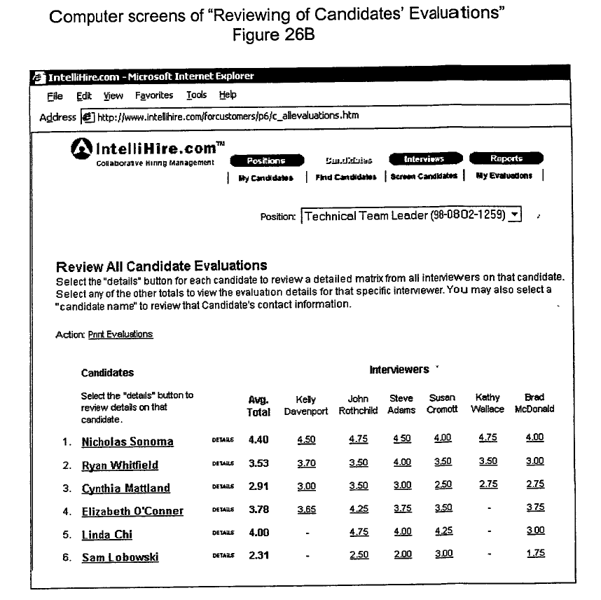

FIG. 22 describes computer screens which define positions. FIG. 23 describes computer screens which coordinate interview teams. FIG. 24 describes computer screens which organize interview questions. FIG. 25 describes computer screens which present guidelines to evaluate candidates. FIG. 26 describes computer screens which present results of review of candidate evaluations.

### STEP 1

### Define Positions

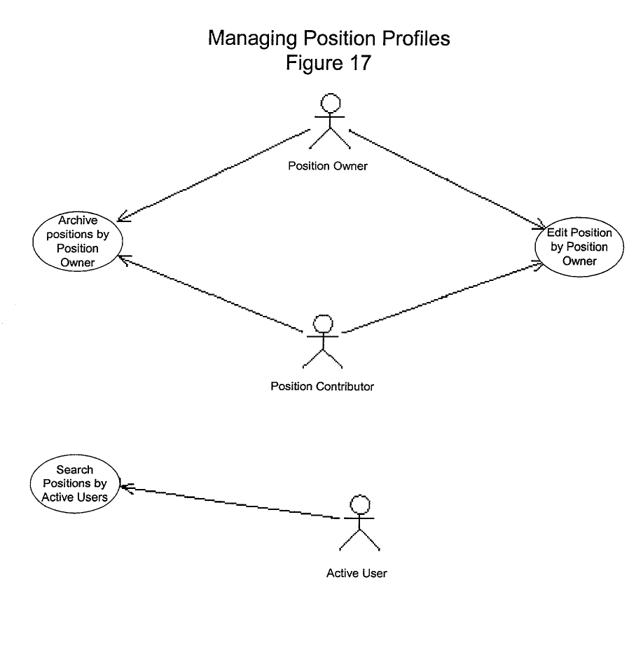

IntelliHire.com™ allows the user to easily manage all of your positions from one location. IntelliHire.com™ provides a proven framework for creating position profiles. Position Profiling involves defining the selection criteria to match candidates to position requirements and obtain the best “candidate-job fit.” IntelliHire.com™ simplifies the process of defining a position by allowing you to select from a database of predefined position profiles. IntelliHire.com™ also enables you to easily edit or copy existing positions. FIGS. 8 and 17 describe how position profiles can be created and managed.

### STEP 2

### Coordinate Interview Teams

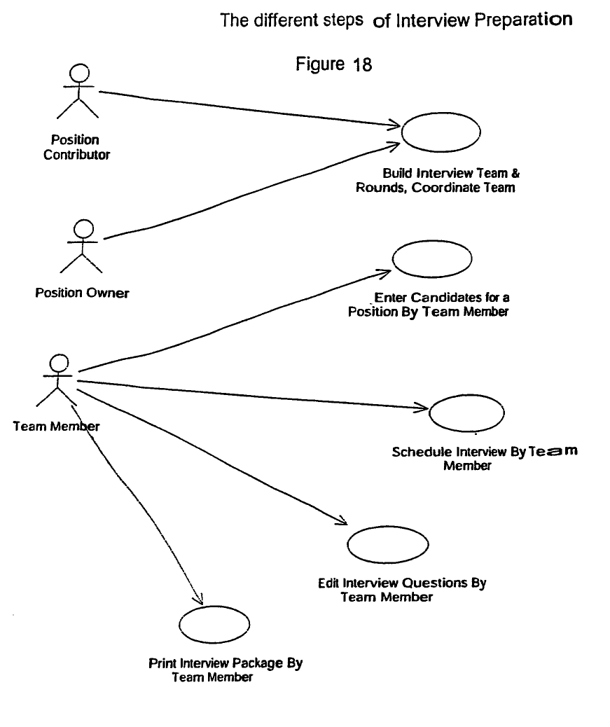

IntelliHire.com™ helps the user coordinate Interviewing Teams and focus interviewer questioning to avoid redundancy. IntelliHire.com™ can then instantly notify team members of their specific assignments via email. By selecting other IntelliHire.com™ users to put onto the interview team, you control who has access to each of your positions. FIG. 18 shows the various steps involved in the interview preparation stage which includes building an Interview team and coordinating the team.

### STEP 3

### Organize Interview Questions

IntelliHire.com™ includes an extensive database of behavioral-event Interview Questions that are specific to each position. IntelliHire.com™ also includes tools to help the user create specific questions which can be added to user's database for easy knowledge sharing. IntelliHire.com™ allows the user to print an Interview Package that includes the position summary, interview questions, and even the candidate's resume.

### STEP 4

### Evaluate Candidates

IntelliHire.com™ allows the user to easily manage all of your candidates from one location. Questions such as: Who they are, where they are, what positions they are being interviewed for, are answered, and even the candidates' resumes can be seen. IntelliHire.com™ captures interviewer feedback quickly in a structured framework that is aligned with the position profile. IntelliHire.com™ then calculates scores based on candidate competency within the selection criteria. The user can also capture interviewer intuition through overall ratings and specific comments.

### STEP 5

### Review Candidate Evaluations

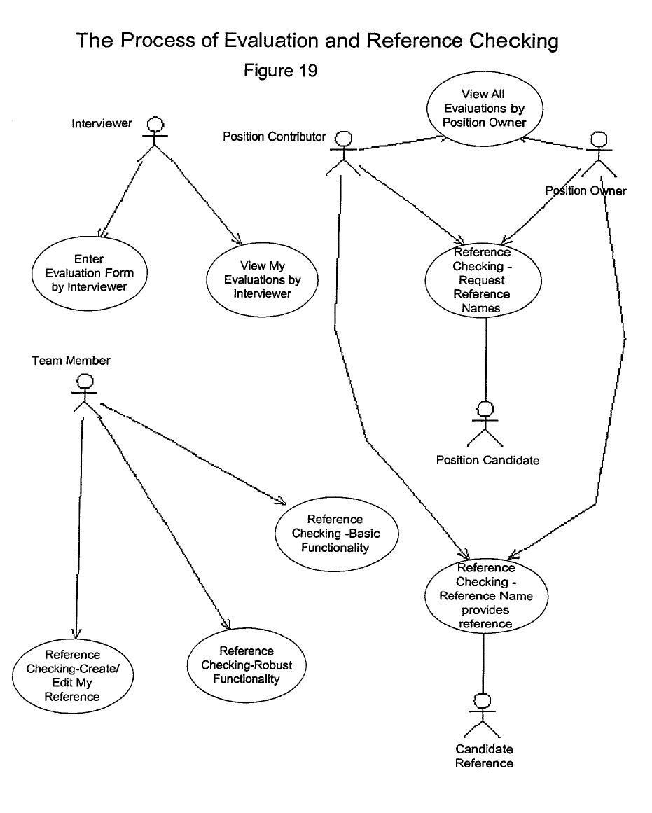

IntelliHire.com™ then organizes and presents all candidate evaluations in empirical forms. The user can view evaluations in several ways allowing hiring managers and recruiters to compare candidates quickly and make more informed, accurate hiring decisions. From a high level you can easily see which candidates best match the position, and then drill down to see the details of why. FIG. 19 gives an example of how the IntelliHire system's users can submit/view the evaluations of candidates, and also check the candidate's references.

The software choices, supported platforms and basic technology framework that form the basis for the design and development phases of the IntelliHire system are deployed for the purpose of development time, reduced costs and optimal hiring practices using currently available state-of-the-art platforms, systems, software and hardware.

System Level Users

There are four different system level users of the IntelliHire system: 1) Basic User, 2) Super User, 3) Customer Administrator (“Admin”) and 4) IntelliHire Administrator.

1) Basic User

A Basic User is assigned Basic access level by the IntelliHire Admin User or through self-registration. The IntelliHire Admin User can promote a Basic User to Super User, but a Basic User cannot change the access level. A Basic User has the ability to search all positions in the system and see the position profile, Owner and position status. A Basic User will not be able to edit/delete any positions that are owned by other Basic Users. Basic Users, who are not owners, will not be able to see Position Salary, Bonus or Other. A Basic User can create position data. If a Basic User is linked to a position in the role of an Owner (or Contributor, Interviewer), the user also has the same access privileges (modify and view) to the position as the Owner (or Contributor, Interviewer) does.

2) Super User

A Basic User becomes a Super User when the Customer Admin user assigns Super access level to the user. A Super User has all the rights as a Basic User, as well as the See All privilege for all public positions and position related information. A Super User also has See All privilege for private positions. Depending on the role of this user for a specific position, this user will have either Create New or Modify or just View privilege for the position.

3) Customer Administrator

The Customer Admin user has authorization to add new users, designate new user's role to either Super or Basic, modify existing users' profile information, reset user password in the IntelliHire System, and System/Database Maintenance. The Customer Admin User will be able to Add User Info, Search/Edit All Users' Information, Reset User's Password, Activate/Deactivate User and Delete Users. FIG. 6 shows the assorted duties of the Customer Administrator.

4) IntelliHire Administrator

This user is responsible for creating new customer accounts and maintaining existing IntelliHire Accounts. FIG. 5 gives an illustration of the different tasks that a IntelliHire administrator can do.

User Roles

Along with the different system level users, there are three User Roles: 1) Position Owner, 2) Position Contributor and 3) Interviewer. Each Basic or Super User can either be a “Position Owner,” “Position Contributor,” or an “Interviewer.”

1) Position Owner

The Position Owner has the ownership (responsibilities) for positions. This user has several rights, such as: Editing Position Data, Editing Questioning Coordination, Creating/Editing/Deleting Interview Questions, and so on.

2) Position Contributor

A Position Contributor contributes to positions that are owned by other users. This user is set by the Position Owner and has all the rights of the Position Owner has except transferring ownership to other users, and setting private/public status of a position. A Contributor does not need to accept/decline when a Position Owner requests the user to be a contributor. If Contributor does not want to act in a contributor role, they can terminate the relationship in My Options. Once a contributor is associated with a position, only the Position Owner can de-assign the contributor. There can be more than one Position Contributor.

3) Interviewers

An Interviewer is associated with a position by a Position Owner or Contributor, and has the following responsibilities for positions: Edit Position Data, Create/Edit/Delete Interview Questions, View Questioning Coordination, Edit Interview Schedules, Add Candidates, Edit/View Own Evaluation

With the interaction of the different system level users and the user roles, the above-mentioned steps of the hiring process are carried out to accomplish the objective of streamlining hiring costs.

System Modules

The various modules comprising IntelliHire include (1) IntelliHire administration module, (2) a Customer Administration module, (3) User modules such as (i) My Positions Module, (ii) My Candidates Module, (iii) My Interviews Module, (iv) My Evaluations Module, (v) My Report Module, and (vi) My Options Module, (4) a Search Module, (5) and a Tutorial Module.

The four main modules within the IntelliHire System are described herein. The Position Module lists the user's view of My Positions. My Positions are all the users associated positions. They can be:

Positions that are owned by the User

Positions that the user is a Contributor

Positions that the user is an interviewer

Positions that the user is a hiring manager

Positions can be in either the Active or Archived category. By default, the system will always display active Positions on the My Positions page. The user can access archived Positions from My Positions page by clicking the Archive button.

The Candidate Module lists the user's view of My Candidates. My Candidates are all the candidates associated with the user. They can be:

Candidates for positions that are owned by the User

Candidates for positions that the user is a Contributor

Candidates for positions that the user is an interviewer

Candidates for positions that the user is a hiring manager

The system will always display active My Candidates.

The Interview Module lists the user's view of My Interviews, My Questions, and Interview Team. My Interviews are all the interviews scheduled and associated with the user, and My Questions are specific to each position. They can be:

Interviews and questions for positions that are owned by the User

Interviews and questions for positions that the user is a Contributor

Interviews and questions for positions that the user is an interviewer

Interviews and questions for positions that the user is a hiring manager

The system will always display active Interviews and Questions.

The Report Module lists the user's view of My Reports. My Reports contain both report templates and user defined customized reports.

The present invention is not to be limited in scope by embodiments disclosed in the examples which are intended as an illustration of one aspect of the invention and any methods which are functionally equivalent are within the scope of the invention. Indeed, various modifications of the invention in addition to those shown and described herein will become apparent to those skilled in the area from the foregoing description. Such modifications are intended to fall within the scope of the appended claims.

What is claimed is:

1. A computer readable medium of instructions configured as a multiple database information exchange management system used in network operations, comprising:
a first database of information pertaining to a job opening, stored in electronically readable memory;
a second database of positions information;
a server and communication port suitable for transmitting and receiving data and instructions in the form of electrical signals to and from remote computers;
a database management system for creating and revising records of said first database and said second database connected to said electronically readable memory responsive to the remote computers;
an interactive database query engine connected to said memory, said engine configured to permit a plurality of searches by a plurality of users, and said searches operate on the results of previous searches, and said results are communicated between all users; and
a process controller connected to said database management system, said interactive database and said server and communication port
wherein said interactive database is a company database containing human resources records.

2. The computer readable medium of instructions according to claim 1, further comprising an accounting system connected to said process controller.

3. The computer readable medium of instructions according to claim 1, further comprising a security means connected to said process controller.

4. The computer readable medium of instructions according to claim 1, wherein the human resources records contain a plurality of search key fields including selection criteria, coordination of interviews, preparation of questions, feedback from interviewers or candidate evaluations.

5. The computer readable medium of instructions according to claim 1, further comprising a database of instructions pertaining to training of users.

6. The computer readable medium of instructions according to claim 4, wherein said interactive database query engine includes means for searching key fields of a database for the satisfaction of one or more conditions, and means for reporting and exchanging all variables in said search key fields of records which satisfy said one or more conditions.

7. The computer readable medium of instructions according to claim 1, wherein said key fields include at least one of: a customer administration key, an interview key, a report key, an options key, a search key or a tutorial key.

8. The computer readable medium of instructions according to claim 5, further comprising means for organizing the hiring process by coordinating the exchange of information at every step of the hiring process between different levels of users assigned for the hiring process.

9. The computer readable medium of instructions according to claim 7, further comprising means to restrict entries in at least one of said search key fields to a predetermined set of entries.

10. A computer software system provided to execute hiring practices intelligently, said system comprising:
a first database of information pertaining to job openings;
a second database of positions information;
a third database of company records compiled by the human resources department, said third database containing user modules, administration modules, option modules, search modules or tutorial modules; and
a database management system connected to the software linking it to multiple databases and multiple remote computers.

11. A method of hiring personnel intelligently, said method comprising the steps of:
creating a computer readable file including information pertaining to job openings;
uploading a portion of the computer readable file to a medium accessible via a computer network;
searching information in the uploaded portion of the computer readable file for the presence of information corresponding to information requested by a user;
accessing the information requested from relevant databases in the network;
making available to the user information requested, and permitting the user to send said information via the computer network to another computer readable file located in the same hiring environment, to exchange said information with another user.

12. The method of hiring personnel intelligently according to claim 11, further comprising the step of updating routinely, the information compiled on hiring practices within a hiring environment.
